(19) United States
(12) Patent Application Publication
(10) Pub. No.: US 2026/0092199 A1
(43) Pub. Date: Apr. 2, 2026

(54) Method of Bonding Substrates

(71) Applicant: Henkel AG & Co. KGaA, Duesseldorf (DE)

(72) Inventors: Michael Doherty, Kildare (IE); Barry Burns, Dublin (IE)

(21) Appl. No.: 19/411,600

(22) Filed: Dec. 8, 2025

Related U.S. Application Data
(63) Continuation of application No. PCT/EP2024/065785, filed on Jun. 7, 2024.

(30) Foreign Application Priority Data
Jun. 8, 2023 (GB) 2308568.1

(51) Int. Cl. C09J 5/02; C23C 30/00

(52) U.S. Cl. CPC C09J 5/02; C23C 30/00

(57) ABSTRACT

A method of bonding first and second substrates to each other, the substrates having respective bonding surfaces to be bonded together, comprising:
(a) applying to the bonding surface of at least the first substrate a redox-active metal catalyst primer to form a primed surface;
(b) activating the primed bonding surface of the first substrate by exposing the primed bonding surface to actinic radiation;
(c) applying, to the so activated bonding surface of the first substrate, and/or or to the bonding surface of the second substrate, an anaerobically curable adhesive which is a non-UV curable anaerobic adhesive; and
(d) mating the bonding surfaces together with the non-UV curable anaerobically curable adhesive there between;
   wherein at least one substrate is an e-coated steel substrate having one of the following coatings in accordance with AISI-ASTM A 976-9: C0, C2, C3, C3A, C4, C4A, C4AS, C5, C5A, C5AS, C6.

### FIELD OF THE INVENTION

The present invention relates to a method of bonding substrates.

### BACKGROUND TO THE INVENTION

It is known in the adhesives industry that certain substrates, are difficult to bond. This may be due to various factors such as low surface energy/low surface tension properties of the materials from which the substrate(s) to be bonded are made.

Various approaches are generally used to bond such difficult to bond materials. For example, adhesive compositions have been specifically formulated for use to bond such substrates. Additionally, or alternatively, primers have been used. Primers are applied to the substrate before subsequent over application of the adhesive. Additionally, or alternatively, surface treatment of the substrates has been employed to make them more susceptible to bonding. Such treatment is often due to a physical effect such as roughening of a surface of the substrate thus making it more susceptible to bonding or a chemical treatment such as with acid.

One challenging type of substrate to bond is a substrate with a coating thereon. This may mean that while the material from which the substrate is formed may be easily bonded the coated material may be more difficult to bond as the coating has different properties.

Of particular interest in relation to the present invention is where the coating is a coating applied as an electrically insulating coating. In the present invention the term “insulation” will refer to electrical insulation.

For example, the substrate may be formed of a metal, such as steel, which is relatively easy to bond. However, the coating makes the substrate much less easy to bond. Furthermore, while removal of at least a part of the coating (for example using techniques described above) can allow bonding, this is undesirable as desirable properties imparted by the coating are lost. In particular it is undesirable to remove a coating that has been applied for the purpose of electrical insulation as of course the loss of such insulation can lead to potential electrical shorts, danger of electrical shock, and associated hazards such as fire, degradation of performance or injury.

Notwithstanding that state-of-the-art proposed solutions to these issues exist, it is desirable to provide alternative solutions so the end user has more choices available.

### SUMMARY OF THE INVENTION

In one aspect, the present invention provides a method as set out in the claims.

It will be appreciated that at least one of the substrates to be bonded together may be an e-coated steel substrate having one of the following coatings as classified according to AISI-ASTM A 976-9 standards: C0, C2, C3, C3A, C4, C4A, C4AS, C5, C5A, C5AS, C6. This is a difficult to bond substrate and is a substrate with a coating applied for the purposes of electrical insulation. In the present invention such a substrate/coating may be referred to as e-coat, e-coated, e-coating etc.

C0, C2, C3, C3A, C4, C4A, C4AS, C5, C5A, C5AS, C6 are coating names as set out in AISI-ASTM A 976-9, which describes the classification of insulating coatings for electrical steels and characterises the coating names C0, C2, C3, C3A, C4, C4A, C4AS, C5, C5A, C5AS, C6.

In the electrical industry such coatings are often applied to parts for electrical/electronic components. The composition that is applied to form the coating is often referred to as a varnish. In this respect the present invention is directed to bonding substrates, and in particular electrical substrates which have been coated with such a varnish. Often times the varnish imparts electrical insulation to the substrate. Typically, the electrical substrates are made from metal such as steel and have been insulated using such a coating.

Of particular interest in the present invention are coated substrates that function utilising electromagnetic induction.

Such coated substrates often form part of electrical devices, including motors, generators, transformers, sensors, and other devices that function by electromagnetic induction. The coatings impart suitable electrical insulation and have sufficient structural integrity to allow operation of the electrical device.

Such insulating coatings may be applied by encapsulation, casting or potting to a suitable substrate.

The coatings are typically epoxy resins, phenolic resins, including phenol/formaldehyde resins, and polyurethane resins.

Siliconised Steel, also known as electrical steel, is steel with silicon added to it. Adding silicon to steel increases its electrical resistance, improves the ability of magnetic fields to penetrate it, and reduces the steel's hysteresis loss. Silicon steel is used in many electrical applications where electromagnetic fields are important, such as electrical stators/rotors and motors, coils, magnetic coils and transformers.

Steel used in electrical applications may also be known as: lamination steel, silicon electrical steel, silicon steel, core plate steel, C5 core plate, or transformer steel.

Some types of steel include: GO Grain Oriented/NGO Non-Grain Oriented/CRML Cold Rolled Motor Lamination.

Electrical insulation coatings are coatings that insulate steel such as silicon steel and they are often pigmented.

Electrical steel insulation coatings are classified according to AISI-ASTM A 976-9 standards. Some Insulation Classes for electrical steel insulation coatings are set out below:

C3/EC-3: These are unfilled, organic based varnishes that deliver increased punch ability and have exceptional insulation properties. Typical applications for these coatings are small motors, transformers and transmitters. A special C3 coating is a self-bonding varnish, which shows the highest level of adhesive properties thanks to its adherence over the whole cross-section, even of complex geometries. It enables electrical device manufacturers to insulate and to adhere steel sheet stacks in one step while still retaining the magnetic properties and the excellent mechanical strength of the electrical steel.

C5/EC-5 coatings are filled organic and inorganic based varnishes ideally used for increased insulation properties, resistance against annealing and improved weldability. Typical applications for these coatings are machines undergoing treatments like welding, Al-die casting or annealing.

C6/EC-6: These are highly-filled organic and inorganic based varnishes that deliver increased insulation properties as well as the required resistance against pressure. Typical applications for these coatings are medium and large machines with high resistance against pressure and temperature.

Electrical Steel Coatings - Insulation classes

| | | For | Anti-stick |
|---|---|---|---|
| Classification | Description | Rotors/Stators | treatment |
| C0 | Natural oxide formed | No | No |
| | during mill processing | | |
| C2 | Glass like film | No | No |
| C3 | Organic enamel or | No | No |
| | varnish coating | | |
| C3A | As C3 but thinner | Yes | No |
| C4 | Coating generated by | No | No |
| | chemical and thermal | | |
| | processing | | |
| C4A | As C4 but thinner and | Yes | No |
| | more weldable | | |
| C4AS | Anti-stick variant of C4 | Yes | Yes |
| C5 | High-resistance similar to | No | No |
| | C4 plus inorganic filler | | |
| C5A | As C5, but more | Yes | No |
| | weldable | | |
| C5AS | Anti-stick variant of C5 | Yes | Yes |
| C6 | Inorganic filled organic | Yes | Yes |
| | coating for insulation | | |
| | properties | | |

The method of the invention is suitable for use with all of the classes of insulation coating given above. The method of the invention utilises a primer, an anaerobic/UV anaerobic adhesive and a UV light source. In this method the area to be bonded is coated with a primer and then exposed for activation by UV light. A UV anaerobic adhesive is applied, the bond is assembled and optionally clamped. The edge of the (clamped) bond is exposed to the UV light. This method can be used to bond e-coated substrates such as e-coated C5 substrates.

The method of the invention utilises a primer, an anaerobic adhesive which is a non-UV curable anaerobic adhesive and a UV light source. In this method the area to be bonded is coated with a primer and then exposed for activation by UV light. An anaerobic adhesive is applied, the bond is assembled and optionally clamped.

The use of UV activated primer with anaerobic adhesives significantly improves the bond strengths in certain applications for example in bonding of e-coat steel for example to another e-coated steel substrate. For example, the method of the invention may be used to achieve greater bonding where both of the substrates to be bonded are coated metal, such as a coated steel for example an e-coat C5 steel. The improved performance is seen when compared to the use of a similar anaerobically curable adhesive alone or an anaerobically curable adhesive plus primer system with no irradiation.

Examples of commercially available e-coated steel suitable for use in the present invention include: Waelzholz M310-65A according to EN10106-supplied with mill certificate to EN 10204-3.1 Waelzholz 2×AN8-C5 classified-2.0-6.0 μm thick per side (100 mm×25 mm×0.5 mm).

The coatings are filled organic and inorganic based varnishes typically applied to steel for increased insulation properties, resistance against annealing and/or improved weldability. Typical applications for these coatings are machines undergoing treatments like welding, Al-die casting or annealing. The coatings may be epoxy based.

The method of the invention is suited for bonding such substrates for example in the assembly of electrical motor parts such as lamination stacks which may require bonding of coated substrates to each other for example in the form of a stack or array. Such coated substrates may be C5 e-coated substrates.

The use of UV activated primer with non-UV curable anaerobic adhesives significantly improves the bond strengths between such substrates, for example of e-coat to e-coat C5 steel, as compared to the use of an anaerobically curable adhesive alone or an anaerobic adhesive with a primer but no UV activation.

For example, the method of the present invention may be used to bond together the individual components forming a lamination stack in an electric motor. For example, a stack within an electric motor may comprise individual stators or rotors bonded together.

The present invention relates to a method of bonding first and second substrates to each other the substrates having respective bonding surfaces to be bonded together, comprising:
(a) applying to the bonding surface of at least the first substrate a redox-active metal catalyst primer to form a primed surface;
(b) activating the primed bonding surface of the first substrate by exposing the primed bonding surface to actinic radiation;
(c) applying, to the so activated bonding surface of the first substrate, and/or or to the bonding surface of the second substrate, an anaerobic adhesive which is a non-UV curable anaerobic adhesive; and
(d) mating the bonding surfaces together with the anaerobic adhesive therebetween,
   wherein at least one substrate is an e-coated steel substrate having one of the following coatings as classified in accordance with AISI-ASTM A 976-9: C0, C2, C3, C3A, C4, C4A, C4AS, C5, C5A, C5AS, C6.

Optionally in a method of the invention,
step (a) comprises applying to the respective bonding surfaces of the first substrate and the second substrate a redox-active metal catalyst primer to form respective primed surfaces; and
step (b) comprises activating the respective primed bonding surfaces of the first substrate and the second substrate by exposing those primed bonding surfaces to actinic radiation.

Suitably step (c) comprises applying, to the so activated bonding surface of the first substrate, and to the so activated bonding surface of the second substrate, an anaerobic adhesive.

Suitably, at least one substrate is an e-coated steel substrate having one of the following coatings as classified in accordance with AISI-ASTM A 976-9: C3. C5. C6.

Preferably, at least one substrate is an e-coated steel substrate having a C5 coating in accordance with AISI-ASTM A 976-9.

The actinic radiation of step (b) may have a wavelength of from about 10 nm to about 10,000 nm; such as from 100 to 700 nm, optionally 300 to 400 nm for example 360 to 380 nm. One useful range is 100 to 400 nm.

The duration of the exposure to the actinic radiation of step (b) may be from 1 to 300 seconds, such as 1.5 to 200 seconds, optionally 2 to 100 seconds, for example 5 to 60 seconds.

The actinic radiation of step (b) may have an intensity of 1 to 5000 mW/cm², such as 20 to 800 mW/cm², suitably 50 to 500 mW/cm², for example 70 to 450 mW/cm².

The total energy to which the primed bonding surface of the first substrate and/or the primed bonding surface of the second substrate is exposed during step (b) is desirably from 1 to 300000 mJ/cm², such as 100 to 200000 mJ/cm², suitably 250 to 100000 mJ/cm², for example 0.5 J/cm² to 40 J/cm².

The total energy to which the UV curable anaerobic adhesive is exposed during step (e) may be from 1 to 300000 mJ/cm², such as 100 to 200000 mJ/cm², suitably 250 to 100000 mJ/cm², for example 0.5 J/cm² to 40 J/cm².

The redox-active metal catalyst primer may comprise a redox-active metal catalyst comprising a transition metal selected from titanium, chromium, manganese, iron, cobalt, nickel, copper, zinc, silver, vanadium, molybdenum, ruthenium, and combinations thereof. Further, the transition metal can be provided in the form of a salt.

The redox-active metal catalyst primer may comprise a redox-active metal catalyst selected from but not limited to cobalt (II) naphthenate; copper carbonate; copper (II) acetylacetonate; copper (II) 2-ethyl hexanoate, copper (II) 2-ethyl hexanoate, copper (II) tetrafluoroborate, silver nitrate; vanadium (III) acetylacetonate, iron (II) naphthenate, copper disodium ethylenediamine tetraacetic acid (EDTA·2Na·Cu(II)), vanadyl acetylacetonate, iron (II) acetate, or a combination thereof.

Suitably the redox-active metal catalyst primer comprises a copper-based primer, for example wherein the redox-active metal catalyst primer comprises at least one Cu II salt. The Cu II salt may be selected from Cu acac (copper (II) acetylacetonate) and copper (II) ethyl hexanoate such as copper (II) 2-ethyl hexanoate and combinations thereof.

The redox-active metal catalyst primer may include a redox-active metal catalyst dissolved in solvent, such as a reactive solvent for example a (meth)acrylate monomer such as hydroxy propyl methacrylate (“HPMA”), methacrylic acid or propylene glycol dimethacrylate and combinations thereof.

Optionally the redox-active metal catalyst primer includes an organic solvent such as acetone, ethyl acetate, isopropanol or dichloromethane.

Desirably the redox-active metal catalyst primer comprises from 0.01 to 1.0%, such as 0.05 to 0.7%, for example 0.1% to 0.6%, by weight based on the total weight of the solution, of an active redox-active metal catalyst such as a copper salt.

The substrate may be a substrate with a coating thereon and further wherein the coating is a coating applied by curing a curable coating composition on the substrate.

The substrate may be steel optionally wherein the substrate forms a part of an electric motor.

The coating may be formed by epoxy resins, phenolic resins, including phenol/formaldehyde resins, and polyurethane resins and combinations thereof.

Adhesives suitable for use in the present invention are anaerobically curable adhesive compositions, also commonly described as anaerobically curable adhesives or anaerobic adhesives, which are non-UV curable.

The term “non-UV curable anaerobic adhesive” relates to an anaerobically curable adhesive composition which does not cure when exposed to UV irradiation, for example an anaerobically curable adhesive composition which does not contain any UV initiators, UV activators, photoinitiators etc.

### Polymerizable (Meth)Acrylate Ester Monomers

(Meth)acrylate monomers suitable for use in the anaerobically curable compositions described herein may be chosen from a wide variety of materials, such as those represented by H₂C═CGCO₂R⁴, where G is hydrogen, halogen or alkyl groups having from 1 to about 4 carbon atoms, and R⁴ is selected from alkyl, cycloalkyl, alkenyl, cycloalkenyl, alkaryl, aralkyl or aryl groups having from 1 to about 16 carbon atoms, any of which may be optionally substituted or interrupted as the case may be with silane, silicon, oxygen, halogen, carbonyl, hydroxyl, ester, carboxylic acid, urea, urethane, carbonate, amine, amide, sulfur, sulfonate, sulfone and the like.

One class of monomers suited for use in this invention comprises acrylate esters having the following general formula:

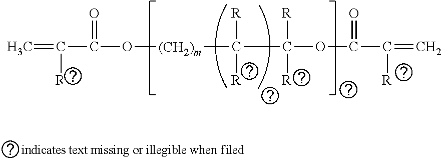

wherein R represents a radical selected from the group consisting of hydrogen, lower alkyl of 1-4 carbon atoms, inclusive, hydroxy alkyl of 1-4 carbon atoms inclusive, and

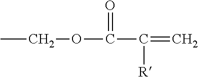

R′ is a radical selected from the group consisting of hydrogen, halogen, and lower alkyl of 1-4 carbon atoms; R″ is a radical selected from the group consisting of hydrogen, —OH and

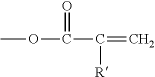

m is an integer equal to at least 1, e.g., from 1 to 8 or higher, for instance, from 1 to 4 inclusive;
n is an integer equal to at least 1, for example, 1 to 20 or more; and p is one of the following: 0, 1.

The polymerizable (meth)acrylate ester monomers utilized in accordance with the invention and corresponding to the above general formula are exemplified by, but not restricted to, the following materials: diethylene glycol dimethacrylate, triethylene glycol dimethacrylate, tetraethylene glycol dimethacrylate, dipropylene glycol dimethacrylate, di-(pentamethylene glycol) dimethacrylate, tetraethylene diglycerol diacrylate, diglycerol tetramethacrylate, tetramethylene dimethacrylate, ethylene dimethacrylate, neopentyl glycol diacrylate and trimethylol propane triacrylate. Of these, the preferred monomers are triethylene glycol dimethacrylate and polyethylene glycol dimethacrylate.

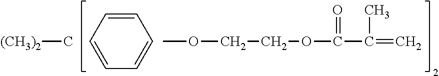

Typical examples of polyacrylate esters corresponding to the above general formula are di-, tri- and tetraethylene glycol dimethacrylate; di(pentamethyleneglycol) dimethacrylate; tetraethyleneglycol diacrylate; tetraethyleneglycol di(chloroacrylate); diglycerol diacrylate; diglycerol tetramethacrylate; butyleneglycol dimethacrylate; neopentylglycol diacrylate; and trimethylolpropane triacrylate.

While di- and other polyacrylate esters, and particularly the polyacrylate esters described in the preceding paragraphs, have been found particularly desirable, monofunctional acrylate esters (esters containing one acrylate group) also may be used. When dealing with monofunctional acrylate esters, it is highly preferable to use an ester which has a relatively polar alcoholic moiety. Such materials are less volatile than low molecular weight alkyl esters and, more important, the polar group tends to provide intermolecular attraction during and after cure, thus producing more desirable cure properties, as well as a more durable sealant or adhesive.

Suitably, the polar group is selected from the group consisting of labile hydrogen, heterocyclic ring, hydroxy, amino, cyano, and halo polar groups. Typical examples of compounds within this category are cyclohexyl methacrylate, tetrahydrofurfuryl methacrylate, hydroxyethyl methacrylate, hydroxypropyl methacrylate, t-butylaminoethyl methacrylate, cyanoethylacrylate, and chloroethyl methacrylate.

Another preferred class of monomers is prepared by the reaction of a monofunctionally substituted alkyl or aryl acrylate ester containing an active hydrogen atom on the functional substituent. This monofunctional, acrylate-terminated material is reacted with an organic polyisocyanate in suitable proportions so as to convert all of the isocyanate groups to urethane or ureide groups.

Additional (meth)acrylate monomers suitable for use herein include polyfunctional (meth)acrylate monomers, such as, but not limited to, di- or tri-functional (meth)acrylates like polyethylene glycol di(meth)acrylates, tetrahydrofuran (meth)acrylates and di(meth)acrylates, hydroxypropyl (meth)acrylate (“HPMA”), hexanediol di(meth)acrylate, trimethylol propane tri(meth)acrylate (“TMPTMA”), diethylene glycol dimethacrylate, triethylene glycol dimethacrylate (“TRIEGMA”), tetraethylene glycol dimethacrylate, dipropylene glycol dimethacrylate, di-(pentamethylene glycol) dimethacrylate, tetraethylene diglycol diacrylate, diglycerol tetramethacrylate, tetramethylene dimethacrylate, ethylene dimethacrylate, neopentyl glycol diacrylate, trimethylol propane triacrylate and bisphenol-A mono and di(meth)acrylates, such as ethoxylated bisphenol-A (meth)acrylate (“EBIPMA”), and bisphenol-F mono and di(meth)acrylates, such as ethoxylated bisphenol-F (meth)acrylate.

Still other (meth)acrylate monomers that may be used herein include silicone (meth)acrylate moieties (“SiMA”), such as those taught by and claimed in U.S. Pat. No. 5,605,999 (Chu), the disclosure of which is hereby expressly incorporated herein by reference.

The polymerizable (meth)acrylate ester monomers may be present in the composition in an amount from about 10 to about 90 weight percent, suitably about 30 to about 70 weight percent, based on the total weight of the composition.

### Redox-Active Metal Catalyst

Cure of the anaerobically curable composition can be initiated by a redox-active metal catalyst comprising a transition metal when the anaerobically curable composition is contacted with the substrate that has been primed with the redox active metal catalyst primer and activated by exposure to actinic radiation and the two substrates mated together and allowed to cure under anaerobic conditions. The redox-active metal catalyst enhances the strength of cure, speed of cure, and combinations thereof of the compositions described herein.

The transition metal included in the redox-active metal catalyst may be titanium, chromium, manganese, iron, cobalt, nickel, copper, zinc, silver, vanadium, molybdenum, ruthenium, and combinations thereof. Further, the transition metal can be provided in the form of a salt. For example, the transition metal salt may be selected from but not limited to the following examples: cobalt (II) naphthenate; copper carbonate; copper (II) acetylacetonate; copper (II) 2-ethyl hexanoate, copper (II) tetrafluoroborate; silver nitrate; vanadium (III) acetylacetonate and combinations thereof. Suitably, the redox-active metal catalyst is iron (II) naphthenate, copper disodium ethylenediamine tetraacetic acid (EDTA·2Na·Cu(II)), or copper naphthenate, vanadium acetylacetonate, vanadyl acetylacetonate, iron (II) acetate, or a combination thereof.

The redox-active metal catalyst may be included in the composition in an amount from about 0.0001 to about 2, suitably about 0.0002 to about 0.5 weight percent, based on the total weight of the composition.

### Peroxide

Peroxides can serve as a free radical generating source which initiate free radical curing of the anaerobically curable compositions described herein. Several well-known initiators of free radical polymerization can be incorporated into the anaerobically curable compositions described herein including, without limitation, peroxides which have a half-life of 10 hours at a temperature between about 80° and 140° C., such as cumene hydroperoxide (“CHP”), para-menthane hydroperoxide, t-butyl hydroperoxide (“TBH”) and t-butyl perbenzoate. Other suitable peroxides include benzoyl peroxide, dibenzoyl peroxide, 1,3-bis(t-butylperoxyisopropyl)benzene, diacetyl peroxide, butyl 4,4-bis(t-butylperoxy) valerate, p-chlorobenzoyl peroxide, t-butyl cumyl peroxide, t-butyl perbenzoate, di-t-butyl peroxide, dicumyl peroxide, 2,5-dimethyl-2,5-di-t-butylperoxyhexane, 2,5-dimethyl-2,5-di-t-butyl-peroxyhex-3-yne, 4-methyl-2,2-di-t-butylperoxypentane and combinations thereof.

Further, hydroperoxides which derive from hydrocarbons with a chain length of 3 to 18 carbon atoms can be included in the compositions described herein. For example, cumene hydroperoxide, tert-butyl hydroperoxide, methyl ethyl ketone hydroperoxide, diisopropyl benzene hydroperoxide.

The peroxide may be present in the composition in an amount from about 0.5 to about 10 weight percent, suitably from about 1 to about 5 weight percent, based on the total weight of the composition.

Suitable compositions which may be used within the present invention include anaerobically curable compositions comprising (i) one or more polymerizable (meth)acrylate ester monomers, (ii) saccharin or a saccharin derivative, and (iii) a peroxide, and desirably those wherein the composition does not gel after about 24 hours of storage at room temperature. The components (i) to (iii) of the invention are distinct components. For example, the redox-active metal catalyst is not a peroxide.

### Optional Components

Additional components can be included in the anaerobically curable compositions disclosed herein such that these additional components do not interfere with the functionality of the components described above.

For example, acrylic acid can be included in the composition to enhance the cure and adhesion in an amount from about 0 to about 20 weight percent, suitably from about 1 to about 10 weight percent, based on the total weight of the composition.

(Meth)acrylate oligomers can further optionally be included in the composition. (Meth)acrylate oligomers can be included to improve fully cured peel strengths of the compositions described herein. For example, (meth)acrylate capped polyurethane oligomers can be included. A variety of commercial urethane (meth)acrylate oligomer resins are known. Suitably, this component is, or includes a block resin such as described in U.S. Pat. No. 4,309,526, comprising at least one polyether block derived from a polyether polyol and at least one hard block derived from an aromatic or cycloaliphatic diisocyanate and an aromatic or cycloaliphatic polyol. Especially preferred are such resins in which the polyether polyol is an aliphatic polyether having a number average molecular weight of from about 400 to about 10,000, more suitably about 700 to about 3,500.

If included, (meth)acrylate oligomers can be present in the anaerobically curable composition in an amount from about 5 to about 90 weight percent, suitably from about 10 to about 50 weight percent, based on the total weight of the composition.

Amines can optionally be included in the composition to cause the monomer to polymerize in the absence of oxygen and prevent polymerization of the monomer in the presence of oxygen.

The nature of the amine is not critical for purposes of the anaerobically curable compositions disclosed herein, i.e., primary, secondary, tertiary, aliphatic or aromatic amines can be used. For example, primary aliphatic amines such as ethyl, n-butyl, n-propyl, isopropyl, n-hexyl and t-butyl amines conveniently can be used. Also, primary aromatic amines, such as aniline, p-toluidine, or p-naphthylamine, xylidine, benzylamine or p-benzylaniline can be used. Aliphatic or aromatic secondary amines also can be used. Typical examples of acceptable secondary amines are diethylamine, dipropylamine, diisopropylamine, diphenylamine, N-phenyl benzylamine and N-allylaniline.

Tertiary amines are organic amines wherein all three valences of the nitrogen atom are satisfied by carbon atoms. Tertiary amines are also suitable for use in the compositions described herein. The carbon atoms in the tertiary amines may be part of alkyl, carbocyclic or heterocyclic groups, either unsubstituted or hydroxyl-substituted. Generally, the trialkylamines and dialkylanilines are most suitably employed. However, alkaloids and other compounds within the scope of the above definition are also suitable for the present invention. Exemplary of the various tertiary amines that may be utilized are triethylamine, tripropylamine, tributylamine, triamylamine, triphenylamine, dimethylaniline, ethyldiethanolamine, triethanolamine and piperidine.

Generally, amines suitable for use in the compositions described herein can be represented by the formula R″—R—NH, wherein R″ is a hydrocarbon radical containing up to about 14 carbon atoms, suitably an aliphatic or aromatic hydrocarbon group containing up to about eight carbon atoms, and R is either hydrogen or R. Naturally, either R″ or R can contain any substituent or linkage, hydrocarbon or otherwise, which does not affect the condensation product adversely for the purpose disclosed herein.

The amine or amines used in the compositions described herein are suitably liquid at room temperature for ease in handling and mixing, although gaseous and solid compounds may be employed by dispersing them in the monomer.

A variety of secondary and tertiary organic amines, suitably secondary aromatic amines can be included in the anaerobically curable compositions disclosed herein.

Amines, suitably secondary aromatic amines, can be included in the composition in an amount up to about 5 weight percent, suitably about 0.001 to about 2 weight percent based on the total weight of the composition.

Chelators can further optionally be included in the composition. Chelators, such as ethylenediamine tetraacetic acid (EDTA), can be employed in the anaerobically curable compositions described herein to sequester metal ions. For example, chelators can be included in the composition in an amount from about 0.0001 to about 1 weight percent, suitably from about 0.0002 to about 0.5 weight percent, based on the total weight of the composition.

Conventional accelerators of free radical polymerization may also be used in the present invention. Such accelerators are typically of the hydrazine variety (e.g., APH), as disclosed in U.S. Pat. No. 4,287,350 (Rich) and 4,321,349 (Rich). When APH is chosen as an accelerator for use herein, maleic acid would usually be added as well.

Other accelerators may also be used in the compositions of the present invention including, without limitation, organic amides and imides, such as benzoic sulfimide (also known as saccharin) (see U.S. Pat. No. 4,324,349). Of course, THQ as well could be used as an accelerator.

Free radical stabilizers can further optionally be included in the composition. Phenols such as hydroquinone, benzoquinone, naphthoquinone, anthraquinone, butylated hydroxytoluene and p-methoxyphenol can be used to prevent premature polymerization due to peroxide decomposition and formation of free radicals. For example, free radical stabilizers can be included in the composition in an amount of about 0.0001 to about 2 weight percent, suitably about 0.0002 to about 0.5 weight percent, based on the total weight of the composition.

Silica and inorganic fillers can also optionally be included in the composition. Silicas can be added to make the composition more viscous, i.e. thixotropic. This is beneficial for non-flow and non-sag properties such as for use in gasket sealing. Suitably, when silica and/or inorganic fillers are included in the composition they are included in an amount of up to about 10 weight percent, suitably up to about 5 weight percent, based on the total weight of the composition.

Additional resins can also optionally be included in the composition. These additional resins can include but are not limited to polyester and polyurethanes. These resins can be included in the composition in an amount of up to about 50 weight percent, suitably up to about 20 weight percent, based on the total weight of the composition.

### DETAILED DESCRIPTION OF THE INVENTION

Described below is a series of experiments highlighting a method to improve adhesion of e-coated to e-coated steel using UV activated primer/activator in conjunction with a non-UV curable anaerobic adhesive.

A method of bonding according to the invention was carried out. Comparative tests/methods were also carried out.

The method of the invention comprises bonding first and second substrates to each other the substrates having respective bonding surfaces to be bonded together, comprising:
(a) applying to the bonding surface of at least the first substrate a redox-active metal catalyst primer to form a primed surface;
(b) activating the primed bonding surface of the first substrate by exposing the primed bonding surface to actinic radiation;
(c) applying, to the so activated bonding surface of the first substrate, and/or or to the bonding surface of the second substrate, an anaerobically curable adhesive which is a non-UV curable anaerobic adhesive; and
(d) mating the bonding surfaces together with the UV curable anaerobic adhesive therebetween;
wherein at least one substrate is an e-coated C5 steel as classified according to AISI-ASTM A 976-9 standards.

One irradiation source used to irradiate the primed substrates was a Loctite® UVALOC 1000 UV Cure Chamber, which is a high-performance modular curing system consisting of a cure chamber, lamp housing, and controller. The chamber has four rack levels to accommodate a slide-in tray that allows for easy positioning of parts of various heights at the level of optimum exposure. A perforated aluminium plate allows positioning of customized part holders. The lamp is shielded by a timed control shutter that eliminates UV exposure to operators during loading or unloading of parts. A door safety switch prevents opening while exposure is in progress. The cure time is controlled by the built-in timer and can be operated in a continuous or timed mode. The exposure cycle is triggered by footswitch, panel-mount start button, or PLC interface.

In all aspects of the present invention where actinic radiation is referred to the actinic radiation is from a light source specifically arranged to irradiate the substrate to be bonded, for example the source is within 1 metre thereof, for example within 30 cm thereof. So, exposure means exposure to the actinic radiation from such a light source and does not include ambient light such as natural light, light from overhead lights etc.

The substrates bonded were C5 e-coated steel. In particular the following e-coated steel was used: Waelzholz M310-65A according to EN10106-supplied with mill certificate to EN 10204-3.1 Waelzholz 2×AN8-C5 classified-2.0-6.0 μm thick per side 100 mm×25 mm.

AN8 is a coating applied by Waelzholz. As above this is a varnish typically applied to steel for increased insulation properties, resistance against annealing and/or improved weldability. Typical applications for these coatings are machines undergoing treatments like welding, Al-die casting or annealing.

The tests were carried out according to the following standards:
(i) ASTM D1002-05 (Oct. 1, 2005) Strength Properties of Adhesives in Shear by Tension Loading (Metal-to-Metal)
(ii) ISO 4587 Adhesives-Determination of Tensile Lap-Shear Strength of High Strength Adhesive Bonds 5.1.4 DIN EN 1465 Adhesives-Determination of Tensile Lap-Shear Strength of Rigid-to-rigid Bonded Assemblies.

For the tests above M310-65A C5 lapshears were used.

The results of initial testing are shown in Table 1.

The anaerobically curable adhesive used was Loctite® 638.

The redox-active metal catalyst primer used was Loctite® 7091. It includes an organocopper compound and reactive methacrylate monomer as solvent.

For Comparative Example 1, Loctite® 638 was applied to the lapshears and the lapshears were clamped together and left at room temperature for 24 h before testing. No priming or irradiation steps were carried out.

For Comparative Example 2, Loctite® 638 and primer Loctite® 7091 were applied to the lapshears. The lapshears were clamped together and left at room temperature for 24 h before testing. No irradiation was carried out.

For Example 1, primer Loctite® 7091 was applied to the lapshears. The lapshears were irradiated for 60 s with the UVALOC 1000 at a radiation of 272 mW/cm². Loctite® 638 was then applied to the lapshears and the lapshears were clamped together and left at room temperature for 24 h before testing.

Each test was run three times.

The tensile shear strengths in N/mm² after 24 hours at room temperature are shown in Table 1.

TABLE 1

| | Tensile shear strengths in N/mm² (after 24 hours @ RT) | | |
|---|---|---|---|
| Sample | Comparative Example 1 | Comparative Example 2 | Example 1 |
| 1 | No cure | 1.68 | 4.62 |
| 2 | | 2.36 | 4.28 |
| 3 | | 2.86 | 3.29 |
| Average | n/a | 2.30 | 4.06 |

The results of Table 1 show that tensile strengths are increased by 75% when the irradiation step is introduced.

Further testing was carried out using a different primer/activator. Results are shown in Table 2.

The redox-active metal catalyst primer used was Loctite® 7649. Loctite® 7649 is a primer solution consisting of an acetone solution of a 2-ethylhexanoate copper salt.

The anaerobically curable adhesive used was Loctite® 648. LOCTITE® 648 is a green, fluorescent, low viscosity, high strength, urethane methacrylate acrylic, anaerobic retaining compound designed for bonding cylindrical fitting parts. It prevents loosening and leakage from shock and vibration. Typical applications include holding gears and sprockets onto gearbox shafts and rotors on electric motor shafts. It provides robust curing performance.

Comparative Example 3 was carried out using the same method as Comparative Example 2 (i.e. without an irradiation step). Example 2 was carried out using the same method as Example 1.

TABLE 2

| | Tensile shear strengths in N/mm² (after 24 hours @ RT) | |
|---|---|---|
| Sample | Comparative Example 3 | Example 2 |
| 1 | 2.15 | 2.99 |
| 2 | 1.67 | 3.20 |
| 3 | 1.71 | 3.65 |
| Average | 1.84 | 3.28 |

Again, the results of Table 2 show that tensile strengths are increased by over 75% when the irradiation step is introduced.

Further testing was carried out using a different anaerobically curable adhesive. The results are shown in Table 3.

The anaerobically curable adhesive used in the testing was Loctite® 648.

The redox-active metal catalyst primer used was Loctite® 7091.

Comparative Example 4 was carried out using the same method as Comparative Example 1 (i.e. with no primer applied and no irradiation). Comparative Example 5 was carried out using the same method as Comparative Example 2 (i.e. without an irradiation step). Example 3 was carried out using the same method as Example 1.

TABLE 3

| | Tensile shear strengths in N/mm² (after 24 hours @ RT) | | |
|---|---|---|---|
| Sample | Comparative Example 4 | Comparative Example 5 | Example 3 |
| 1 | 1.33 | 1.41 | 4.62 |
| 2 | No cure | 2.20 | 3.04 |
| 3 | No cure | 2.10 | 6.31 |
| Average | 1.33 | 1.90 | 4.66 |

The results of Table 3 show that tensile strengths are increased by 145% when the irradiation step is introduced.

Further testing was carried out using the combination of Loctite® 648 as the anaerobically curable adhesive and Loctite® 7649 as the redox-active metal catalyst primer. Results are shown in Table 4.

Comparative Example 6 was carried out using the same method as Comparative Example 1 (i.e. with no primer applied and no irradiation). Comparative Example 7 was carried out using the same method as Comparative Example 2 (i.e. without an irradiation step). Example 4 was carried out using the same method as Example 1.

TABLE 3

| | Tensile shear strengths in N/mm² (after 24 hours @ RT) | | |
|---|---|---|---|
| Sample | Comparative Example 6 | Comparative Example 7 | Example 4 |
| 1 | 1.33 | 1.55 | 4.44 |
| 2 | No cure | 2.00 | 4.39 |
| 3 | No cure | 1.75 | 4.15 |
| Average | 1.33 | 1.77 | 4.33 |

In all testing carried out, activation/priming of the substrates is essential for achieving a reliable cure. Furthermore, irradiation of the primed substrates was shown to increase tensile strength by up to 145% compared to the same method carried out without the irradiation step.

C5 e-coated steel bonded according to methods of the invention cured reliably and with high tensile strengths when compared to the same substrates bonded with standard adhesive products.

The words “comprises/comprising” and the words “having/including” when used herein with reference to the present invention are used to specify the presence of stated features, integers, steps or components but do not preclude the presence or addition of one or more other features, integers, steps, components or groups thereof.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

1. A method of bonding first and second substrates to each other, the substrates having respective bonding surfaces to be bonded together, comprising:
(a) applying to the bonding surface of at least the first substrate a redox-active metal catalyst primer to form a primed surface;
(b) activating the primed bonding surface of the first substrate by exposing the primed bonding surface to actinic radiation;
(c) applying, to the so activated bonding surface of the first substrate, and/or or to the bonding surface of the second substrate, an anaerobically curable adhesive which is a non-UV curable anaerobic adhesive; and
(d) mating the bonding surfaces together with the non-UV curable anaerobically curable adhesive there between;
wherein at least one substrate is an e-coated steel substrate having one of the following coatings in accordance with AISI-ASTM A 976-9: C0, C2, C3, C3A, C4, C4A, C4AS, C5, C5A, C5AS, C6.

2. A method according to claim 1 wherein:
step (a) comprises applying to the respective bonding surfaces of the first substrate and/or the second substrate a redox-active metal catalyst primer to form respective primed surfaces; and
step (b) comprises activating the respective primed bonding surfaces of the first substrate and/or the second substrate by exposing those primed bonding surfaces to actinic radiation.

3. A method according to claim 1 wherein step (c) comprises applying, to the so activated bonding surface of the first substrate, and to the so activated bonding surface of the second substrate, an anaerobically curable adhesive which is a non-UV curable anaerobic adhesive.

4. A method according to claim 1 wherein at least one substrate is an e-coated steel substrate having a C3, C5, or C6 coating in accordance with AISI-ASTM A 976-9.

5. A method according to claim 1 wherein at least one substrate is an e-coated steel substrate having a C5 coating in accordance with AISI-ASTM A 976-9.

6. A method according to claim 1 wherein the actinic radiation of step (b) has a wavelength of from about 10 nm to about 10,000 nm.

7. A method according to claim 1 wherein the duration of the exposure to the actinic radiation of step (b) is from 1 to 300 seconds.

8. A method according to claim 1 wherein the actinic radiation of step (b) has an intensity of 20 to 5000 mW/cm².

9. A method according to claim 1 wherein the total energy to which the primed bonding surface of the first substrate and/or the primed bonding surface of the second substrate is exposed during step (b) is from 1 to 300000 mJ/cm².

10. A method according to claim 1 wherein the redox-active metal catalyst primer comprises a redox-active metal catalyst selected from cobalt (II) naphthenate; copper carbonate; copper (II) acetylacetonate; silver nitrate; vanadium (III) acetylacetonate, iron (II) naphthenate, copper (II) 2-ethyl hexanoate, copper (II) 2-ethyl hexanoate, copper (II) tetrafluoroborate, copper disodium ethylenediamine tetraacetic acid (EDTA·2Na·Cu(II)), vanadyl acetylacetonate, iron (II) acetate, or a combination thereof.

11. A method according to claim 1 wherein the redox-active metal catalyst primer comprises a copper-based primer.

12. A method according to claim 1 wherein the redox-active metal catalyst primer comprises at least one Cu II salt.

13. A method according to claim 12 wherein the Cu II salt is selected from Cu (II) acac (copper (II) acetylacetonate) and copper (II) ethyl hexanoate and combinations thereof.

14. A method according to claim 1 wherein the redox-active metal catalyst primer includes a the redox-active metal catalyst dissolved in a solvating agent.

15. A method according to claim 1 wherein the redox-active metal catalyst primer includes an organic solvent.

16. A method according to claim 1 wherein the redox-active metal catalyst primer comprises from 0.01 to 1.0% by weight based on the total weight of the solution, of an active redox-active metal catalyst.

17. A method according to claim 1 wherein the first substrate and the second substrate are both e-coated steel substrates having one of the following coatings in accordance with AISI-ASTM A 976-9: C0, C2, C3, C3A, C4, C4A, C4AS, C5, C5A, C5AS, C6.

18. A method according to claim 1 wherein the first substrate and the second substrate are both e-coated steel having a C5 coating as classified according to AISI-ASTM A 976-9 standards.

19. A method according to claim 1 wherein at least one substrate forms a part of an electric motor.

20. A method according to claim 1 wherein at least one substrate has a coating formed from an epoxy resin, a phenolic resin, including phenol/formaldehyde resins, or a polyurethane resin or combinations thereof.
